(19) United States
(12) Patent Application Publication
(10) Pub. No.: US 2014/0052443 A1
(43) Pub. Date: Feb. 20, 2014

(54) ELECTRONIC DEVICE WITH VOICE CONTROL FUNCTION AND VOICE CONTROL METHOD

(71) Applicant: TZU-CHIAO SUNG, Tu-Cheng (TW)

(72) Inventor: TZU-CHIAO SUNG, Tu-Cheng (TW)

(21) Appl. No.: 13/666,877

(22) Filed: Nov. 1, 2012

(30) Foreign Application Priority Data
Aug. 16, 2012 (TW) 101129785

(51) Int. Cl. G10L 15/00

(52) U.S. Cl. 704/236

(57) ABSTRACT

A voice control method of an electronic device is provided. The method includes detecting external voice around, changing detected voices into voices signals; periodically sensing non-vocal physical actions of the user, and identifying the action; comparing the identified action with a preset action to determine whether the identified action is same as the preset action; extracting voice characteristic of linguistic meaning from the voice signals when the signals are received; determining whether the extracted voice characteristic of linguistic meaning matches voice templates stored in a storage unit; and performing a particular function associated with the voice template when the storage unit stores the voice template corresponding to the voice characteristic of linguistic meaning. The electronic device is also provided.

### BACKGROUND

1. Technical Field

The present disclosure relates to electronic devices and particularly to an electronic device with voice control function and voice control method.

2. Description of Related Art

A user may use fingers to operate buttons or interfaces of an electronic device to perform functions. However, if one or both hands are occupied, the user is not able to operate the electronic device.

Therefore, it is desirable to provide an electronic device and a method for controlling the electronic device by voice, which can overcome the above-mentioned shortcomings.

### BRIEF DESCRIPTION OF THE DRAWINGS

FIG. 1 is a functional block diagram of an electronic device with voice control function, according to a first embodiment.

FIG. 2 is a flowchart showing a method for controlling the electronic device of FIG. 1 by voice.

### DETAILED DESCRIPTION

Embodiments of the disclosure will be described with reference to the accompanying drawings.

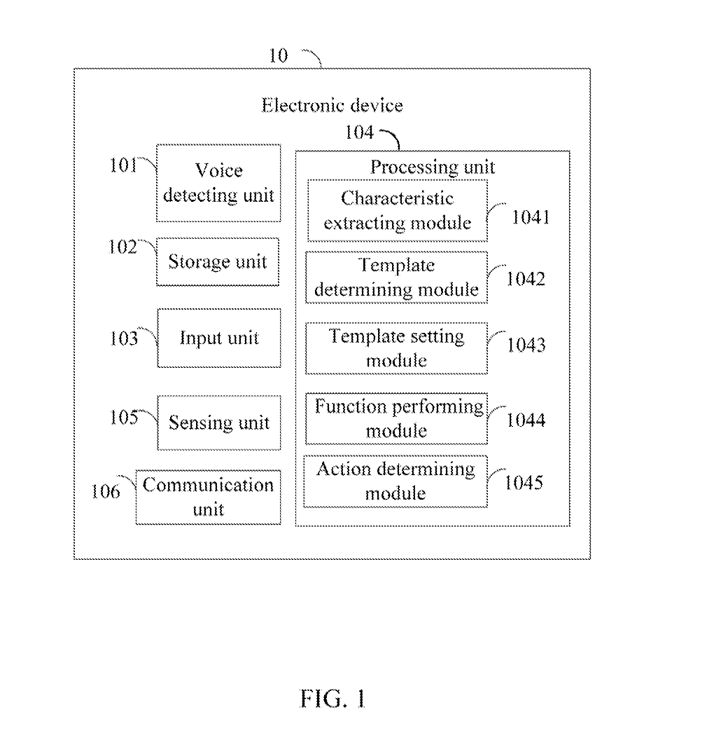

Referring to FIG. 1, a functional block diagram of an electronic device with voice control function is provided. The electronic device 10 is a portable electronic terminal, such as a TV, a mobile phone or the like. The electronic device 10 includes a voice detecting unit 101, a storage unit 102, an input unit 103, a processing unit 104, and a sensing unit 105.

The voice detecting unit 101 detects external voices, changes the sound of the voice into voice signals, and sends the voice signals to the processing unit 104. The storage unit 102 provides space for storing data. The input unit 103 receives manual inputs by a user. The sensing unit 105 periodically senses non-vocal physical actions of the user, and identifies the actions, for example, the action may be nodding or shaking of the head, or hand waving. The sensing unit 105 may be a gyroscope sensor. Methods of identifying non-vocal physical actions can be found by existing knowledge.

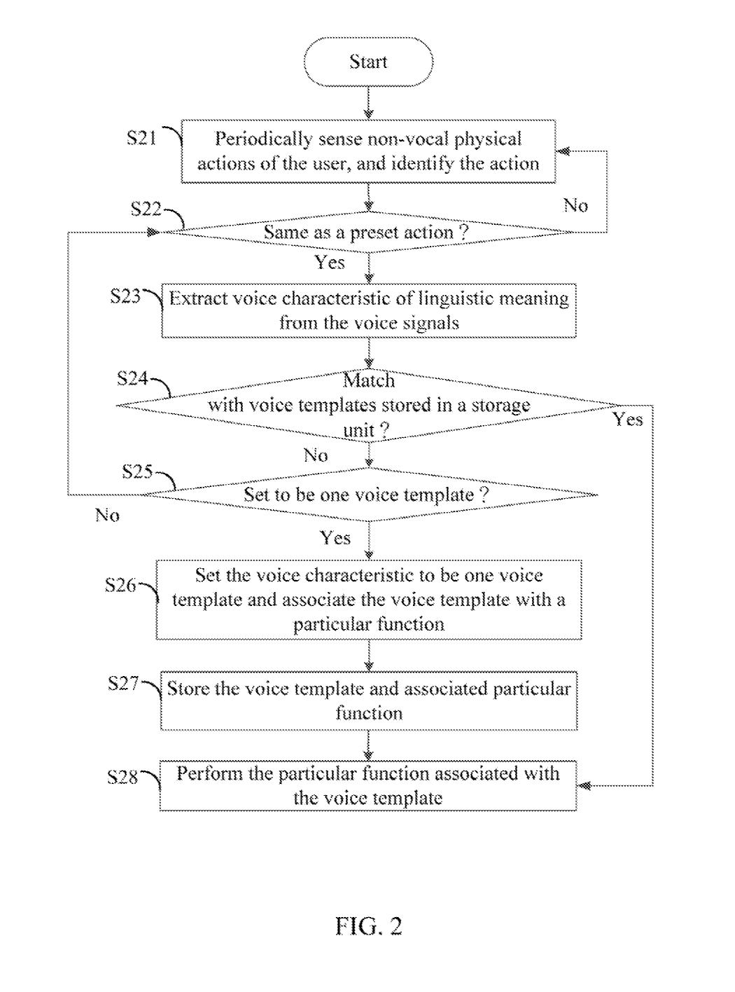

The processing unit 104 includes a characteristic extracting module 1041, a template determining module 1042, a template setting module 1043, a function performing module 1044, and an action determining module 1045. Functions of the modules will be described with reference to FIG. 2.

FIG. 2 is a flowchart showing a method for controlling the electronic device of FIG. 1 by voice.

In step S21, the sensing unit 105 periodically senses non-vocal physical actions of the user, and identifies the action.

In step S22, the action determining module 1045 determines whether the identified action is same as a preset action. If yes, the procedure goes to the step S23, otherwise, the flow of the method goes back to the step S21. The preset actions are preset by the user, for example, the preset action may be clapping the hands. If the identified action is nodding the head, then the action determining module 1045 determines the identified action is not same as one preset action.

In step S23, the characteristic extracting module 1041 extracts voice characteristic of linguistic meaning from the voice signals detected by the voice detecting unit 101.

In step S24, the template determining module 1042 determines whether the voice characteristic of linguistic meaning matches voice templates stored in the storage unit 102, if yes, the procedure goes to step S28, otherwise, the procedure goes to step S25. The voice templates are preset in the storage unit 102, examples of these are “page down,” “page up,” “turn on,” and “turn off.

In step S25, the template setting module 1043 determines whether the user wants to set the voice characteristic of linguistic meaning to be one voice template, if yes, the procedure goes to the step S26, otherwise, the procedure goes to the step S22. The method of determining whether the user wants to set the voice characteristic of linguistic meaning to be one voice template can be: generating an interface including a menu to indicate the user to select whether to set the voice characteristic of linguistic meaning to be one voice template, when the menu is selected, then setting the voice characteristic of linguistic meaning to be one voice template is determined.

In step S26, the template setting module 1043 sets the voice characteristic of linguistic meaning to be one voice template, and associates the voice template with a particular function through the input unit 103, e.g., when the voice says “Page up”, the particular function may be scrolling up a page.

In step S27, the template setting module 1043 stores the voice template and the associated particular function into the storage unit 102 through the input unit 103.

In step S28, the function performing module 1044 performs the particular function associated with the voice template.

In other embodiments, the electronic device 10 further includes a communication unit 106 for supplying network connection function. The function performing module 1044 controls other electronic devices in network to perform the particular function associated with the voice template through the communication unit 106. The sensing unit 105 can periodically sense non-vocal physical actions of the user from other electronic devices in network through the communication unit 106. The voice detecting unit 101 can also detect external voice from around other electronic devices in network through the communication unit 106.

Though the method above, the electronic device 10 can perform the particular functions associated with the preset user action through voice control when the identified action is same as one preset action.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An electronic device with voice control function, comprising:
a processing unit;
a voice detecting unit, to detect external voice around, change detected voices into voice signals, and send the voice signals to the processing unit;
a storage unit, to provide space for storing data; and
a sensing unit, to periodically sense a non-vocal physical action of the user and identify the action;
the processing unit comprising:
an action determining module, to compare the identified action with a preset action to determine whether the identified action is same as the preset action;
a characteristic extracting module, to extract voice characteristic of linguistic meaning from the voice signals detected by the voice detecting unit;
a template determining module, to determine whether the extracted voice characteristic of linguistic meaning matches voice templates stored in the storage unit; and
a function performing module, to perform a particular function associated with the voice template when the storage unit stores the voice template corresponding to the voice characteristic of linguistic meaning.

2. The electronic device according to claim 1, further comprising a template setting module to determine whether a user wants to set the voice characteristic of linguistic meaning to be one voice template when the storage unit does not store the voice template corresponding to the voice characteristic of linguistic meaning, set the voice characteristic of linguistic meaning to be one voice template when determining to set the voice characteristic of linguistic meaning to be one voice template, associate the voice template with a particular function, and store the voice template and associated particular function into the storage unit.

3. The electronic device according to claim 2, wherein the template setting module determines whether the user wants to set the voice characteristic of linguistic meaning to be one voice template by: generating an interface including a menu to indicate to the user to select whether to set the voice characteristic of linguistic meaning to be one voice template, and setting the voice characteristic of linguistic meaning to be one voice template is determined when the menu is selected.

4. The electronic device according to claim 3, further comprising an input unit to receive inputs by a user, wherein the template setting module sets the voice characteristic of linguistic meaning to be one voice template, and associates the voice template with a particular function through the input unit.

5. The electronic device according to claim 2, wherein the sensing unit is a gyroscope sensor.

6. The electronic device according to claim 1, further comprising a communication unit to supply network connection function, wherein the function performing module controls other electronic devices in network to perform the particular function associated with the voice template through the communication unit.

7. The electronic device according to claim 1, further comprising a communication unit to supply network connection function, wherein the sensing unit periodically senses non-vocal physical actions of the user from other electronic devices in network through the communication unit.

8. The electronic device according to claim 1, further comprising a communication unit to supply network connection function, wherein the voice detecting unit detects external voice from around other electronic devices in network through the communication unit.

9. A voice control method of an electronic device, comprising:
detecting external voice around, changing detected voices into voice signals;
periodically sensing non-vocal physical actions of the user, and identifying the action;
comparing the identified action with a preset action to determine whether the identified action is same as the preset action;
extracting voice characteristic of linguistic meaning from the voice signals;
determining whether the extracted voice characteristic of linguistic meaning matches voice templates stored in a storage unit; and
performing a particular function associated with the voice template when the storage unit stores the voice template corresponding to the voice characteristic of linguistic meaning.

10. The voice control method according to claim 9, further comprising determining whether a user wants to set the voice characteristic of linguistic meaning to be one voice template when the storage unit does not store the voice template corresponding to the voice characteristic of linguistic meaning, setting the voice characteristic of linguistic meaning to be one voice template when determining to set the voice characteristic of linguistic meaning to be one voice template, associating the voice template with a particular function, and storing the voice template and associated particular function into the storage unit.

11. The voice control method according to claim 10, further comprising determining whether the user wants to set the voice characteristic of linguistic meaning to be one voice template by: generating an interface including a menu to indicate to the user to select whether to set the voice characteristic of linguistic meaning to be one voice template, and setting the voice characteristic of linguistic meaning to be one voice template is determined when the menu is selected.

12. The voice control method according to claim 9, further comprising controlling other electronic devices in network to perform the particular function associated with the voice template through network connection function.

13. The electronic device according to claim 9, further comprising periodically sensing non-vocal physical actions of the user from other electronic devices in network through network connection function.

14. The electronic device according to claim 9, wherein the method of periodically sensing non-vocal physical actions of the user, identifying the action further comprises periodically sensing non-vocal physical actions of the user, and identifying the action by a sensing unit, and the sensing unit is a gyroscope sensor.
